(19) United States
(12) Patent Application Publication
(10) Pub. No.: US 2022/0371590 A1
(43) Pub. Date: Nov. 24, 2022

(54) Model-Based Predictive Control of a Drive Machine of the Powertrain of a Motor Vehicle and at Least One Vehicle Component Which Influences the Energy Efficiency of the Motor Vehicle

(71) Applicant: ZF Friedrichshafen AG, Friedrichshafen (DE)

(72) Inventors: Timon Busse, München (DE); Matthias Friedl, Friedrichshafen (DE); Detlef Baasch, Oberteuringen (DE); Valerie Engel, Markdorf (DE)

(21) Appl. No.: 17/771,321

(22) PCT Filed: Oct. 25, 2019
(86) PCT No.: PCT/EP2019/079152

§ 371 Date: Apr. 22, 2022

(51) Int. Cl. B60W 30/18; B60W 50/00; B60W 10/22; B60W 10/18; B60W 40/12; B60W 40/10; B60W 10/08

(52) U.S. Cl. CPC B60W 30/18; B60W 50/0097; B60W 10/22; B60W 10/18; B60W 40/12; B60W 40/10; B60W 10/08; B60W 2050/0013

(57) ABSTRACT

A processor unit (3) is configured for executing an MPC algorithm (13) for model predictive control of a prime mover (8) and of at least one vehicle component influencing energy efficiency of a motor vehicle. The MPC algorithm (13) includes a longitudinal dynamic model (14) of the drive train (7) and of the vehicle component influencing the energy efficiency of the motor vehicle (1) as well as a cost function (15) to be minimized. The cost function (15) includes at least one first term. The processor unit (3) is configured for determining a particular input variable for the prime mover (8) and for the at least one vehicle component influencing the energy efficiency of the motor vehicle (1) by executing the MPC algorithm (13) as a function of a particular term such that the cost function (15) is minimized.

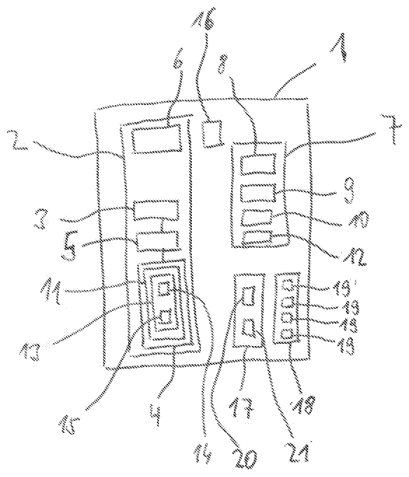

### CROSS-REFERENCE TO RELATED APPLICATION

The present application is a U.S. national phase of PCT/EP2019/079152 filed in the European Patent Office on Oct. 25, 2019, which is incorporated by reference in its entirety for all purposes.

### FIELD OF THE INVENTION

The invention relates generally to a model predictive control of a prime mover of a drive train and of at least one vehicle component of a motor vehicle influencing the energy efficiency of the motor vehicle.

### BACKGROUND

Methods of model predictive control (MPC) are utilized in the field of closed-loop trajectory control, in particular, in the area of closed-loop prime mover control in motor vehicles. For example, Schwickart proposes an approach to quadratic programming in his work “Energy-Efficient Driver Assistance System For Electric Vehicles Using Model-Predictive Control” (Schwickart, T., Université du Luxembourg, dissertation, 2015). According thereto, a reformulation of a system model is carried out in order to obtain a linear or quadratic problem that converges and is numerically easily solved. EP 2 610 836 A1 describes an optimization of an energy management strategy on the basis of a prediction horizon and further surroundings information by minimizing a cost function. In the process, a neural network is created for use in the vehicle and a modeling of the driver and a prediction of the speed profile likely selected by the driver are carried out. Moreover, EP 1 256 476 B1 discloses a strategy for reducing the energy demand during driving and for increasing the range. In the process, navigation unit information is utilized, namely a current vehicle position, road patterns, geography with date and time, altitude changes, speed limits, intersection density, traffic control, and driving patterns of the driver.

The driver and his/her driving style have an enormous influence on energy consumption during the operation of a motor vehicle. Known cruise control systems do not take energy consumption into account, however. In addition, predictive driving strategies are typically rules-based and, thus, do not yield optimal results in every situation. Optimization-based strategies, furthermore, require a large amount of computing time and previously have been known only as an off-line solution or are solved with dynamic programming.

### SUMMARY OF THE INVENTION

Example aspects of the present invention provide an improved MPC for a prime mover of a drive train of a motor vehicle and of at least one vehicle component influencing the energy efficiency of the motor vehicle.

Example aspects of the present invention provide an optimization of the energy consumption of the motor vehicle during the journey based on the knowledge of losses of the drive train as well as of the particular vehicle component influencing the energy efficiency of the motor vehicle. For this purpose—as explained in greater detail in the following—focus is placed, in particular, on the optimization of driving resistances. The utilization of a reference speed can be completely dispensed with.

The method of model predictive control (MPC) was selected in order to find, in any situation under established marginal conditions and constraints, an optimal solution for a “driving efficiency” driving function, which is to provide an efficient driving style. The MPC method is based on a system model that describes the behavior of the system. In addition, the MPC method is based on an objective function or on a cost function that describes an optimization problem and determines which state variables are to be minimized. The state variables for the “driving efficiency” driving function can be, in particular, the vehicle speed of the motor vehicle, the energy remaining in the battery, the driving time, the aerodynamic drag of the motor vehicle, and the residual friction torque in one or multiple brake unit(s), for example, disk brakes of a braking system of the motor vehicle. Energy consumption and driving time are optimized, in particular, on the basis of the uphill grade of the upcoming route and constraints for speed and drive force, on the basis of the current system state, on the basis of the vehicle level above the roadway, and/or on the basis of the losses due to friction arising within the disk brakes of the motor vehicle due to residual friction torques.

According to a first example aspect of the invention, a processor unit is provided for the model predictive control of a prime mover of a drive train of a motor vehicle and of at least one vehicle component influencing the energy efficiency of the motor vehicle. The processor unit is configured for executing an MPC algorithm for the model predictive control of the prime mover and of the at least one vehicle component influencing the energy efficiency of the motor vehicle. The MPC algorithm includes a longitudinal dynamic model of the drive train and of the vehicle component influencing the energy efficiency of the motor vehicle as well as a cost function to be minimized. The cost function includes at least one first term, which includes a particular power loss weighted with a particular weighting factor and predicted according to the longitudinal dynamic model, which the motor vehicle undergoes while covering a distance predicted within a prediction horizon. The processor unit is configured for determining a particular input variable for the prime mover and for the at least one vehicle component influencing the energy efficiency of the motor vehicle by executing the MPC algorithm as a function of the particular term such that the cost function is minimized. The at least one vehicle component influencing the energy efficiency of the motor vehicle is provided for influencing and/or at least temporarily preventing losses that arise during the propulsion or during the operation of the motor vehicle and, as a result, in particular, reducing the energy consumption of the motor vehicle.

Preferably, the cost function includes, as a first term, an aerodynamic drag weighted with a first weighting factor and predicted according to the longitudinal dynamic model, to which the motor vehicle is subjected while covering a distance predicted within the prediction horizon. The processor unit is configured for determining the particular input variable for the prime mover and for the at least one vehicle component influencing the energy efficiency of the motor vehicle by executing the MPC algorithm as a function of the first term such that the cost function is minimized. The aerodynamic drag is an integral part of the total driving resistance of a motor vehicle and, thereby, is part of the sum of all resistances that a vehicle must overcome with the aid of a drive force in order to travel at a constant or accelerated speed on a horizontal or inclined route. The aerodynamic drag increases quadratically with the driving speed and is dependent on the aerodynamic shape of the vehicle (drag coefficient) and the air density. Further factors for describing the aerodynamic drag are, among other things, the resistance coefficient (drag coefficient) as well as the projected frontal area of the motor vehicle. The frontal area as well as the resistance coefficient are influenceable or changeable via the vehicle component influencing the energy efficiency of the motor vehicle.

In this sense, the vehicle component influencing the energy efficiency of the motor vehicle according to a first exemplary embodiment is a height-adjustable chassis of the motor vehicle, wherein the processor unit is configured for adjusting a vehicle level. In other words, one additional degree of freedom is granted to the driving strategy planned by the processor unit and, in fact, the use of the height-adjustable chassis, in order to plan the speed trajectory of the motor vehicle over the upcoming route section in an energy-optimal manner. In particular, the height-adjustable chassis, which is, for example, hydraulically actuatable, includes multiple actuators for the stepless adjustment of the vehicle level. Preferably, each shock-absorbing strut of the motor vehicle is operatively connected to an actuator of this type, wherein the particular actuator adjusts, for example, a spring plate of the motor vehicle. Via the cooperation of multiple actuators, the height of the passenger car superstructure is steplessly adjusted, wherein, as a result, the frontal area of the motor vehicle as well as the resistance coefficient are enlarged or reduced and increased or decreased, respectively. A lowering of the chassis brings about a reduction of the frontal area of the motor vehicle and of the resistance coefficient and, finally, of the aerodynamic drag. Depending on the driving situation, this advantageously results in an improvement of the aerodynamics and, thereby, energy savings. Depending on the type of drive of the prime mover, this means a reduction of carbon dioxide (CO2) emissions or of electrical energy. Consequently, the motor vehicle is operated more energy efficiently by lowering the vehicle level. By comparison, raising the vehicle level brings about an increase in ride comfort. In other words, by the processor unit under consideration of the upcoming route section, a suitable strategy is selected for lowering and/or raising the vehicle level, which takes the energy efficiency as well as the ride comfort into consideration.

An input variable for the prime mover as well as for the height-adjustable chassis is determined by executing the MPC algorithm as a function of the first term such that the cost function is minimized. In other words, an optimal speed trajectory of the motor vehicle for the upcoming route section or the prediction horizon is planned on the basis of the route topology, the traffic, and further state variables of the motor vehicle, or information about the route, wherein the trajectory is additionally improved by suitably adjusting the vehicle level. In particular, the vehicle height along the prediction horizon is planned by the processor unit. In addition, due to the MPC optimization of the trajectory of the motor vehicle, it is avoided, on the one hand, that unnecessary energy is consumed due to the unskillful activation of the lifting and lowering system of the chassis, or that an unintentional lowering of the chassis takes place even though the route topology, the traffic, or the further state variables of the motor vehicle enables a certain higher level of ride comfort.

According to one further example embodiment, the cost function includes, as a second term, a residual friction torque weighted with a second weighting factor and predicted according to the longitudinal dynamic model, which results in losses at the vehicle component influencing the energy efficiency of the motor vehicle while covering a distance predicted within the prediction horizon, wherein the vehicle component influencing the energy efficiency of the motor vehicle includes at least one disk brake having a brake disk and a brake shoe.

Preferably, the processor unit is configured for determining the particular input variable for the prime mover and for the particular disk brake by executing the MPC algorithm as a function of the first term and as a function of the second term such that the cost function is minimized.

Example aspects of the invention provide that a residual friction torque is temporarily adjusted under consideration of the longitudinal dynamic model, which is configured for providing current power losses of the motor vehicle, which originate, for example, from a vehicle sensor system or from a vehicle model. In conventional motor vehicle brakes, a constant (sliding) contact of brake shoe and brake disk of the particular disk brake, which generates a permanent power loss, has previously usually been present. Such losses are accepted because, among other things, the constant contact with the brake disk allows an immediate utilization of the brake and, thereby, the safety of the motor vehicle increases significantly. In contrast thereto, a permanent gap between the brake shoe and the brake disk would make it necessary, upon actuation of the brake, for a certain distance between the components to be initially overcome before a brake pressure can be built up to enable a braking effect. This has undesirable safety-related disadvantages, which are absolutely to be avoided.

In this sense, the processor unit is configured for adjusting a gap between the brake disk and the brake shoe of the particular disk brake. In other words, one additional degree of freedom is granted to the driving strategy planned by the processor unit and, in fact, the use of the mechanical brakes, in order to plan the speed trajectory of the motor vehicle for the upcoming route section and the prediction horizon in an energy-optimal manner. The processor unit implements—along the trajectory or along the upcoming route section or for the upcoming distance—a temporary separation of the particular brake shoe from the associated brake disk, in particular in driving situations and on route sections in which there is no braking risk or there is a braking risk below a certain limit value, for example, on the basis of the route topography, the vehicle state, and/or the current traffic and/or the traffic arising ahead of the motor vehicle in the direction of travel. Consequently, no residual friction torque is generated in these driving situations, and so no power losses due to residual friction torques are present and, simultaneously, the energy efficiency of the motor vehicle increases. By comparison, before or in driving situations having an elevated braking risk or if high negative accelerations are predicted, a (sliding) contact is established between the brake disk and the brake shoe of the particular disk brake, in order to ensure, in the case of a necessary braking procedure, the desired immediate braking effect upon actuation of the brake. The processor knows at an early stage exactly when which driving situations are present, and so a particular input variable for the prime mover and for the particular disk brake can therefore be determined. On the basis of the present invention, a brake is therefore created, in which friction has been minimized with respect to the residual friction torques within the disk brake.

The prior art, in particular Schwickart (see above), teaches a speed reference as the basis for the MPC controller. In addition to an increased energy consumption, deviations from this reference speed are penalized in the objective function. Schwickart has also alternatively researched a formulation that gets by without reference speed and, instead, penalizes a deviation from a defined permitted speed range. Schwickart has not assessed this formulation as advantageous, since, due to the second term in the objective function, which minimizes the energy consumption, the solution is always at the lower edge of the permitted speed range. This is also similarly the case, however, when the speed reference is utilized. As soon as the term that penalizes the deviation from the speed reference is relaxed, the evaluation of the energy consumption results in a reduction of the driving speed. A deviation from the reference will always take place in the direction of lower speeds.

In order to counteract this, example aspects of the present invention provide that the objective function or the cost function of the “driving efficiency” driving strategy includes one more term, as the result of which the driving time, in addition to the energy consumption, is also minimized. As a result, depending on the selection of the weighting factors, a low speed cannot always be evaluated as optimal and, thus, the problem no longer exists that the resultant speed is always at the lower edge of the permitted speed.

Example aspects of the present invention make it possible that the driver influence is no longer relevant for the energy consumption and the driving time of the motor vehicle, because the prime mover as well as the at least one vehicle component influencing the energy efficiency of the motor vehicle can be controlled by the processor unit based on the particular input variable, which is determined by executing the MPC algorithm. By the particular input variable, in particular, an optimal prime mover operating point of the prime mover can be set. As a result, a direct regulation of the optimal speed of the motor vehicle can be carried out.

Preferably, the cost function includes, as a third term, an electrical energy weighted with a third weighting factor and predicted according to the longitudinal dynamic model, which is provided within a prediction horizon by a battery of the drive train for driving the prime mover. In addition, the cost function includes, as a fourth term, a driving time weighted with a fourth weighting factor and predicted according to the longitudinal dynamic model, which the motor vehicle needs in order to cover the entire distance predicted within the prediction horizon. The processor unit is configured for determining the particular input variable or a particular input signal for the prime mover and for the at least one vehicle component influencing the energy efficiency of the motor vehicle by executing the MPC algorithm as a function of the first term, as a function of the second term, as a function of the third term, and as a function of the fourth term such that the cost function is minimized. In addition, the processor unit can be configured for controlling, by way of an open-loop system, the prime mover and/or the at least one vehicle component influencing the energy efficiency of the motor vehicle based on the particular input variable.

The energy consumption and the driving time of the motor vehicle can both be evaluated and weighted at the end of the horizon. The particular term is therefore active only for the last point of the horizon. In this sense, the cost function in one example embodiment includes an energy consumption final value weighted with the third weighting factor, which the predicted electrical energy assumes at the end of the prediction horizon, and the cost function includes a driving time final value weighted with the fourth weighting factor, which the predicted driving time assumes at the end of the prediction horizon.

According to a second example aspect of the invention, a motor vehicle is provided. The motor vehicle includes a drive train having a prime mover, at least one vehicle component influencing the energy efficiency of the motor vehicle, and a driver assistance system. The prime mover is designed, for example, as an electric machine, wherein the drive train includes, in particular, a battery. Moreover, the drive train includes, in particular, a transmission. The driver assistance system is configured for accessing, by a communication interface, an input variable for the prime mover and an input variable for the at least one vehicle component influencing the energy efficiency of the motor vehicle, wherein the particular input variable has been determined by a processor unit according to the first example aspect of the invention. In addition, the driver assistance system can be configured for controlling, by way of an open-loop system, the prime mover and/or the at least one vehicle component influencing the energy efficiency of the motor vehicle based on the particular input variable. The vehicle is, for example, a motor vehicle such as an automobile (for example, a passenger car having a weight of less than three and a half tons (3.5 t)), a bus, or a truck (bus and truck, for example, having a weight of over three and a half tons (3.5 t)). The vehicle can belong, for example, to a vehicle fleet. The vehicle can be controlled by a driver, possibly assisted by a driver assistance system. The vehicle can also be, for example, remotely controlled and/or (semi-)autonomously controlled, however.

According to a third example aspect of the invention, a method is provided for the model predictive control of a prime mover of a drive train and of at least one vehicle component of a motor vehicle influencing the energy efficiency of the motor vehicle. According to the method, an MPC algorithm for the model predictive control of a prime mover of a drive train and of at least one vehicle component of a motor vehicle influencing the energy efficiency of the motor vehicle is executed by a processor unit. The MPC algorithm includes a longitudinal dynamic model of the drive train and of the vehicle component influencing the energy efficiency of the motor vehicle as well as a cost function to be minimized, wherein the cost function includes at least one first term, which includes a particular power loss weighted with a particular weighting factor and predicted according to the longitudinal dynamic model, which the motor vehicle undergoes while covering a distance predicted within a prediction horizon. In addition, a particular input variable for the prime mover and for the at least one vehicle component influencing the energy efficiency of the motor vehicle is determined as a function of the particular term by executing the MPC algorithm by the processor unit such that the cost function is minimized. In addition, according to the method according to example aspects of the invention, the prime mover as well as the at least one vehicle component influencing the energy efficiency of the motor vehicle can be controlled, by way of an open-loop system, based on the particular input variable.

According to a fourth example aspect of the invention, a computer program product is provided for the model predictive control of a prime mover of a drive train as well as of at least one vehicle component of a motor vehicle influencing the energy efficiency of the motor vehicle, wherein the computer program product, when run on a processor unit, instructs the processor unit to execute an MPC algorithm for the model predictive control of a prime mover of a drive train as well as of at least one vehicle component of a motor vehicle influencing the energy efficiency of the motor vehicle. The MPC algorithm includes a longitudinal dynamic model of the drive train and of the vehicle component influencing the energy efficiency of the motor vehicle as well as a cost function to be minimized, wherein the cost function includes at least one first term, which includes a particular power loss weighted with a particular weighting factor and predicted according to the longitudinal dynamic model, which the motor vehicle undergoes while covering a distance predicted within a prediction horizon. In addition, the computer program product, when run on the processor unit, instructs the processor unit to determine a particular input variable for the prime mover and for the at least one vehicle component influencing the energy efficiency of the motor vehicle by executing the MPC algorithm as a function of the particular term such that the cost function is minimized. Moreover, the computer program product, when run on the processor unit, can instruct the processor unit to control, by way of an open-loop system, the prime mover as well as the at least one vehicle component influencing the energy efficiency of the motor vehicle based on the particular input variable.

The longitudinal dynamic model of the drive train can include a vehicle model with vehicle parameters and drive train losses (in part, approximated characteristic maps). In particular, findings regarding upcoming route topographies (for example, curves and uphill grades) can be incorporated into the longitudinal dynamic model of the drive train. In addition, findings regarding speed limits on the upcoming route can also be incorporated into the longitudinal dynamic model of the drive train. The longitudinal dynamic model also provides information about currently arising power losses, such as, for example, losses due to friction or information about the driving resistance, in particular the aerodynamic drag. The longitudinal dynamic model is provided, in particular, for mathematically estimating losses in the motor vehicle.

The cost function has exclusively linear and quadratic terms. As a result, the overall problem has the form of a quadratic optimization with linear constraints and a convex problem results, which can be solved well and quickly. The objective function or the cost function can be formulated with a weighting (weighting factors), wherein, in particular, an energy efficiency, a driving time, and a ride comfort are calculated and weighted. An energy-optimal speed trajectory can be calculated online for an upcoming horizon on the processor unit, which can form, in particular, an integral part of a central control unit of the motor vehicle. By utilizing the MPC method, moreover, the target speed of the motor vehicle can be cyclically recalculated based on the current driving mode and the upcoming route information.

Current state variables can be measured and appropriate data can be recorded and supplied to the MPC algorithm. In this way, route data from an electronic map can be updated, in particular cyclically, for a prediction horizon, preferably up to five kilometers (5 km) ahead of the motor vehicle. The route data can include, for example, uphill grade information, curve information, and information about speed limits and traffic lights as well as traffic light cycles. Moreover, a curve curvature can be converted, via a maximum permissible lateral acceleration, into a speed limit for the motor vehicle. In addition, a position finding of the motor vehicle can be carried out, in particular via a GNSS signal for the precise localization on the electronic map.

Due to the cost function of the MPC algorithm, a minimization of the aerodynamic drag and/or a minimization of the residual friction torques in the braking system are/is carried out. In one example embodiment, a minimization of the driving time for the prediction horizon is also carried out. In one further example embodiment, a minimization of consumed energy is also carried out. With respect to the input for the model predictive control, for example, speed limits, traffic light locations, traffic light cycles, traffic information, losses resulting from friction and/or aerodynamic drag, physical limits for the torque, and rotational speeds of the prime mover can be supplied to the MPC algorithm as constraints. In addition, control variables for the optimization can be supplied as input to the MPC algorithm, in particular the speed of the vehicle (which can be proportional to the rotational speed), the torque of the prime mover, the state of charge of the battery, as well as the loss due to friction and/or the aerodynamic drag, to which the motor vehicle is subjected during the journey. As the output of the optimization, the MPC algorithm can yield an optimal rotational speed and an optimal torque for calculated points in the prediction horizon. Moreover, the MPC algorithm can deliver, as the output of the optimization, an optimal height of the vehicle level or an optimal distance between the brake disk and the brake shoe of the particular disk brake. With respect to the implementation of the MPC in the vehicle, a software module can be connected downstream from the MPC algorithm, which determines a currently relevant state and transmits this to a power electronics unit.

The preceding comments apply similarly for the processor unit according to the first example aspect of the invention, for the vehicle according to the second example aspect of the invention, for the method according to the third example aspect of the invention, and for the computer program product according to the fourth example aspect of the invention.

### BRIEF DESCRIPTION OF THE DRAWINGS

Exemplary embodiments of the invention are explained in greater detail in the following with reference to the sole diagrammatic drawing, wherein identical or similar elements are labeled with the same reference character, wherein

The FIGURE shows a highly simplified view of a vehicle including a drive train, which includes a prime mover and a battery, as well as a vehicle component influencing the energy efficiency of the motor vehicle according to a first example embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The FIGURE shows a motor vehicle 1, for example, a passenger car. The motor vehicle 1 includes a system 2 for the model predictive control of a prime mover of a drive train of the motor vehicle 1 as well as multiple vehicle components influencing the energy efficiency of the motor vehicle 1. The first vehicle component influencing the energy efficiency of the motor vehicle 1 is a disk brake 17 represented by way of example, wherein the motor vehicle 1 can also include multiple disk brakes designed similarly thereto, for example, at each wheel of the motor vehicle 1. The disk brake 17 includes a brake disk 20 and a brake shoe 21, wherein, due to a frictional connection of the brake disk 20 with the brake shoe 21, a braking effect or a negative acceleration of the motor vehicle 1 is achievable. The second vehicle component influencing the energy efficiency of the motor vehicle 1 is a chassis 18, wherein the chassis 18 includes multiple actuators 19 in the present case, which are operatively connected to shock-absorbing struts (not shown here) in the area of the wheels at the present motor vehicle 1. A height adjustment of the vehicle level can be implemented by actuating one or all actuator(s) 19.

The system 2 includes a processor unit 3, a memory unit 4, a communication interface 5, and a detection unit 6 for detecting state data related to the motor vehicle 1. The motor vehicle 1 also includes a drive train 7, which can include, for example, a prime mover 8, which can be operated as a motor and as a generator, a battery 9, and a transmission 10. The prime mover 8, in the motor mode, can drive wheels of the motor vehicle 1 via the transmission 10, which can have, for example, a constant ratio. The electrical energy necessary therefor is provided by the battery 9 in this case. The battery 9 is chargeable by the prime mover 8 when the prime mover 8 is operated in the generator mode (recuperation). Optionally, the battery 9 can also be charged at an external charging station. Likewise the drive train 7 of the motor vehicle 1 can optionally include an internal combustion engine 12, which, alternatively or in addition to the prime mover 8, can drive the motor vehicle 1. The internal combustion engine 12 can also drive the prime mover 8 in order to charge the battery 9.

A computer program product 11 can be stored on the memory unit 4. The computer program product 11 can be run on the processor unit 3, for the purpose of which the processor unit 3 and the memory unit 4 are connected to each other by the communication interface 5. When the computer program product 11 is run on the processor unit 3, the computer program product 11 instructs the processor unit 3 to perform the functions described in the following and/or to carry out method steps.

The computer program product 11 includes an MPC algorithm 13. The MPC algorithm 13 includes a longitudinal dynamic model 14 of the drive train 7 of the motor vehicle 1 and of the vehicle component influencing the energy efficiency of the motor vehicle 1 as well as a cost function 15 to be minimized. The processor unit 3 executes the MPC algorithm 13 and thereby predicts a behavior of the motor vehicle 1 for an upcoming route section (for example, five kilometers (5 km)) based on the longitudinal dynamic model 14, wherein the cost function 15 is minimized. The optimization by the MPC algorithm 13 yields, as the output, an optimal gap between the brake disk 20 and the brake shoe 21 of the disk brake 17 and/or an optimal vehicle level for calculated points in the prediction horizon. For this purpose, the processor unit 3 can determine an input variable for the disk brake 17, and so, on the one hand, a gap between the brake disk 20 and the brake shoe 21 is adjusted. Depending on the route section, a gap can essentially switch between a first state of actuation, in which the brake disk 20 and the brake shoe 21 are in (sliding) contact, which negatively affects power losses, and a second state of actuation, in which the brake disk 20 and the brake shoe 21 are spaced apart from one another in order to temporarily avoid a residual friction torque. On the other hand, the processor unit 3 can also determine an input variable for the chassis 18 such that a vehicle level of the motor vehicle 1 is adjusted. The vehicle level can be adapted by the actuators 19 such that, depending on the route section, a frontal area of the motor vehicle 1 is enlarged or reduced, which, the larger the frontal area is or becomes, negatively affects the aerodynamic drag and, thereby, similarly affects the energy efficiency of the motor vehicle 1.

In addition, an optimal rotational speed and an optimal torque of the prime mover 8 for calculated points in the prediction horizon result as the output of the optimization by the MPC algorithm 13. For this purpose, the processor unit 3 can determine an input variable for the prime mover 8, enabling the optimal rotational speed and the optimal torque to set in. The processor unit 3 can control, by way of an open-loop system, the prime mover 8 as well as the particular vehicle component influencing the energy efficiency of the motor vehicle 1 based on the determined input variable. In addition, this can also be carried out by a driver assistance system 16, however.

The detection unit 6 can measure current state variables of the motor vehicle 1, record appropriate data, and supply the current state variables and data to the MPC algorithm 13. In this way, route data from an electronic map can be updated, in particular cyclically, for a prediction horizon (for example, 5 km) ahead of the motor vehicle 1. The route data can include, for example, uphill grade information, curve information, information about speed limits or the traffic arising on the route section, as well as information about upcoming traffic lights or traffic light cycles. Moreover, a curve curvature can be converted, via a maximum permissible lateral acceleration, into a speed limit for the motor vehicle 1. In addition, a position finding of the motor vehicle can be carried out by the detection unit 6, in particular via a GPS signal generated by a GNSS sensor 12 for the precise localization on the electronic map. The processor unit 3 can access this information, for example, via the communication interface 5.

The cost function 15 has exclusively linear and quadratic terms. As a result, the overall problem has the form of a quadratic optimization with linear constraints and a convex problem results, which can be solved well and quickly.

The cost function 15 includes, as a first term, an aerodynamic drag weighted with a first weighting factor and predicted according to the longitudinal dynamic model 14, to which the motor vehicle 1 is subjected while covering a distance predicted within the prediction horizon. The cost function 15 includes, as a second term, a residual friction torque weighted with a second weighting factor and predicted according to the longitudinal dynamic model 14, which results in losses at the vehicle component influencing the energy efficiency of the motor vehicle while covering the distance predicted within the prediction horizon. As a result, an energy-optimal speed trajectory for the motor vehicle is selected for the upcoming route section.

The cost function 15 includes, as a third term, an electrical energy weighted with a third weighting factor and predicted according to the longitudinal dynamic model, which is provided within a prediction horizon by the battery 9 of the drive train 7 for driving the prime mover 8. The cost function 15 includes, as a fourth term, a driving time weighted with a fourth weighting factor and predicted according to the longitudinal dynamic model 14, which the motor vehicle 1 needs in order to cover the predicted distance. As a result, depending on the selection of the weighting factors, a low speed cannot always be evaluated as optimal and, thus, the problem no longer exists that the resultant speed is always at the lower edge of the permitted speed.

The processor unit 3 is configured for determining the particular input variable for the prime mover 8 and for the at least one vehicle component influencing the energy efficiency of the motor vehicle by executing the MPC algorithm 13 as a function of the first term, as a function of the second term, as a function of the third term, and as a function of the fourth term such that the cost function is minimized and, as a result, an energy-efficient operation of the motor vehicle 1 is implemented.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 vehicle
2 system
3 processor unit
4 memory unit
5 communication interface
6 detection unit
7 drive train
8 prime mover
9 battery
10 transmission
11 computer program product
12 internal combustion engine
13 MPC algorithm
14 longitudinal dynamic model
15 cost function
16 driver assistance system
17 disk brake
18 chassis
19 actuator
20 brake disk
21 brake shoe

1-11. (canceled)

12. A system for model predictive control of a prime mover (8) of a drive train (7) of a motor vehicle (1) and of at least one vehicle component influencing energy efficiency of the motor vehicle (1), comprising:
a processor unit (3) configured for executing an MPC algorithm (13) for model predictive control of a prime mover (8) and of at least one vehicle component influencing energy efficiency of a motor vehicle (1), the MPC algorithm (13) comprising a longitudinal dynamic model (14) of the drive train (7) and of the at least one vehicle component influencing the energy efficiency of the motor vehicle (1), the MPC algorithm (13) comprising a cost function (15) to be minimized, the cost function (15) comprising
at least one first term that comprises a power loss weighted with a particular weighting factor and predicted according to the longitudinal dynamic model (14), which the motor vehicle (1) undergoes while covering a distance predicted within a prediction horizon, the at least one first term comprising an aerodynamic drag weighted with a first weighting factor and predicted according to the longitudinal dynamic model (14), to which the motor vehicle (1) is subjected while covering the distance predicted within the prediction horizon,
wherein the processor unit (3) is configured for determining a particular input variable for the prime mover (8) and for the at least one vehicle component influencing the energy efficiency of the motor vehicle by executing the MPC algorithm (13) as a function of the particular term such that the cost function (15) is minimized, and
wherein the at least one vehicle component influencing the energy efficiency of the motor vehicle (1) comprises a height-adjustable chassis (18) of the motor vehicle (1), and the processor unit (3) is configured for adjusting a vehicle level.

13. The processor unit (3) of claim 12, wherein the height-adjustable chassis (18) comprises a plurality of actuators (19) for stepless adjustment of the vehicle level.

14. The processor unit (3) of claim 12, wherein:
the cost function (15) comprises, as a second term, a residual friction torque weighted with a second weighting factor and predicted according to the longitudinal dynamic model (14), which results in losses at the at least one vehicle component influencing the energy efficiency of the motor vehicle (1) while covering the distance predicted within the prediction horizon; and
the at least one vehicle component influencing the energy efficiency of the motor vehicle (1) comprises at least one disk brake (17) with a brake disk (20) and a brake shoe (21).

15. The processor unit (3) of claim 14, wherein the processor unit (3) is configured for determining the particular input variable for the prime mover (8) and for the at least one disk brake (17) by executing the MPC algorithm (13) as a function of the first term and as a function of the second term such that the cost function (15) is minimized.

16. The processor unit (3) of claim 15, wherein the processor unit (3) is configured for adjusting a gap between the brake disk (20) and the brake shoe (21) of the at least one disk brake (17).

17. The processor unit (3) of claim 14, wherein:
the cost function (15) comprises, as a third term, an electrical energy weighted with a third weighting factor and predicted according to the longitudinal dynamic model (14), which is provided within a prediction horizon by a battery (9) of the drive train (7) to drive the prime mover (8);
the cost function (15) comprises an energy consumption final value weighted with the third weighting factor, which the predicted electrical energy assumes at an end of the prediction horizon;
the cost function (15) comprises, as a fourth term, a driving time weighted with a fourth weighting factor and predicted according to the longitudinal dynamic model (14), which the motor vehicle (1) requires to cover the entire distance predicted within the prediction horizon;
the cost function (15) comprises a driving time end value weighted with the fourth weighting factor, which the predicted driving time assumes at the end of the prediction horizon; and
the processor unit (3) is configured for determining the particular input variable for the prime mover (8) and for the at least one vehicle component influencing the energy efficiency of the motor vehicle (1) by executing the MPC algorithm (13) as a function of the first term, as a function of the second term, as a function of the third term, and as a function of the fourth term such that the cost function (15) is minimized.

18. A motor vehicle (1), comprising:
a driver assistance system (16);
a drive train (7) with a prime mover (8); and
at least one vehicle component influencing an energy efficiency of the motor vehicle (1),
wherein the driver assistance system (16) is configured for
accessing, via a communication interface, a particular input variable for the prime mover (8) and for the at least one vehicle component influencing the energy efficiency of the motor vehicle (1), wherein the particular input variable has been determined by the processor unit (3) of claim 12, and
controlling, by way of an open-loop system, one or more of the prime mover (8) and the at least one vehicle component influencing the energy efficiency of the motor vehicle (1) based on the input variable.

19. A method for model predictive control of a prime mover (8) of a drive train (7) of a motor vehicle (1) and of at least one vehicle component influencing energy efficiency of the motor vehicle (1), the method comprising:
executing, by a processor unit (3), an MPC algorithm (13) for model predictive control of a prime mover (8) of a drive train (7) and of at least one vehicle component of a motor vehicle (1) influencing energy efficiency of the motor vehicle (1), the MPC algorithm (13) comprising a longitudinal dynamic model (14) of the drive train (7) and of the at least one vehicle component influencing the energy efficiency of the motor vehicle (1) as well as a cost function (15) to be minimized, the cost function (15) comprising
at least one first term that comprises a power loss weighted with a particular weighting factor and predicted according to the longitudinal dynamic model (14), which the motor vehicle (1) undergoes while covering a distance predicted within a prediction horizon, the at least one first term comprising an aerodynamic drag weighted with a first weighting factor and predicted according to the longitudinal dynamic model (14), to which the motor vehicle (1) is subjected while covering the distance predicted within the prediction horizon; and
determining a particular input variable for the prime mover (8) and for the at least one vehicle component influencing the energy efficiency of the motor vehicle (1) as a function of the particular term by executing the MPC algorithm (13) by the processor unit (3) such that the cost function (15) is minimized,
wherein the at least one vehicle component influencing the energy efficiency of the motor vehicle (1) comprises a height-adjustable chassis (18) of the motor vehicle (1), and the processor unit (3) is configured for adjusting a vehicle level.

20. A computer program product (11) for model predictive control of a prime mover (8) of a drive train (7) of a motor vehicle (1) and of at least one vehicle component influencing energy efficiency of the motor vehicle (1), wherein the computer program product (11), when run on a processor unit (3), instructs the processor unit (3) to
execute an MPC algorithm (13) for model predictive control of a prime mover (8) of a drive train (7) and of at least one vehicle component of a motor vehicle (1) influencing energy efficiency of the motor vehicle (1), wherein the MPC algorithm (13) comprises a longitudinal dynamic model (14) of the drive train (7) and of the vehicle component influencing the energy efficiency of the motor vehicle (1) as well as a cost function (15) to be minimized, the cost function (15) comprising
at least one first term that comprises a power loss weighted with a particular weighting factor and predicted according to the longitudinal dynamic model (14), which the motor vehicle (1) undergoes while covering a distance predicted within a prediction horizon, the at least one first term comprising an aerodynamic drag weighted with a first weighting factor and predicted according to the longitudinal dynamic model (14), to which the motor vehicle (1) is subjected while covering the distance predicted within the prediction horizon; and
determine a particular input variable for the prime mover (8) and for the at least one vehicle component influencing the energy efficiency of the motor vehicle (1) by executing the MPC algorithm (13) as a function of the particular term such that the cost function (15) is minimized,
wherein the vehicle component influencing the energy efficiency of the motor vehicle (1) comprises a height-adjustable chassis (18) of the motor vehicle (1), and the processor unit (3) is configured for adjusting a vehicle level.
